(19) United States
(12) Patent Application Publication
(10) Pub. No.: US 2010/0131496 A1
(43) Pub. Date: May 27, 2010

(54) PREDICTIVE INDEXING FOR FAST SEARCH

(75) Inventors: Alexander L. STREHL, Astoria, NY (US); Sharad GOEL, New York, NY (US); John LANGFORD, White Plains, NY (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/324,154

(22) Filed: Nov. 26, 2008

(51) Int. Cl. G06F 17/30; G06Q 30/00

(52) U.S. Cl. 707/722; 707/E17.014; 707/E17.017

(57) ABSTRACT

A system comprises a machine readable storage medium having an index that, given a set of inputs, a set of outputs, a set of input categories, and a scoring rule, provides an ordered subset of the outputs for each input category. The outputs within each subset are ordered by predicted score with respect to an input from one of the input categories. At least one processor is capable of receiving an input corresponding to at least one of the set of input categories. The processor is configured for scoring a reduced set of outputs against the received input using the scoring rule. The reduced set of outputs includes a union of the subsets of outputs associated with each input category to which the received inputs correspond. The processor is configured for outputting a list including a subset of the reduced set of outputs having the highest scores.

### FIELD OF THE INVENTION

The present invention relates to systems and methods for indexing and searching data to maximize a given scoring rule.

### BACKGROUND

The objective of any database search is to quickly return the set of most relevant documents given a particular query string. For example, in a web search, it is desirable to quickly return the set of most relevant web pages given the particular query string. Accomplishing this task for a fixed query involves both determining the relevance of potential documents (e.g., pages) and then searching over the myriad set of all pages for the most relevant ones. Consider the second task. Let Q⊂Rⁿ be an input space, W⊂R^{m} a finite output space of size N, and f: Q×W→R a known scoring function. Given an input (search query) q∈Q, the goal is to find, or closely approximate, the top-k output objects (e.g., web pages) p₁, . . . , pₖ in W (i.e., the top k objects as ranked by ƒ (q,·)).

The extreme speed constraint, often 100 ms or less, and the large number of web pages (N≅10¹⁰) makes web search a computationally-challenging problem. Even with perfect 1000-way parallelization on modern machines, there is far too little time to directly evaluate against every page when a particular query is submitted. This observation limits the applicability of machine-learning methods for building ranking functions.

Given the substantial importance of large-scale search, a variety of techniques have been developed to address the rapid ranking problem. One such technique is use of an inverted index. An inverted index is a data structure that maps every page feature x to a list of pages p that contain x. When a new query arrives, a subset of page features relevant to the query is first determined. For instance, when the query contains “dog”, the page feature set might be {“dog”, “canine”, “collar”,}. Note that a distinction is made between query features and page features, and in particular, the relevant page features may include many more words than the query itself. Once a set of page features is determined, their respective lists (i.e., inverted indices) are searched, and from them the final list of output pages is chosen.

Approaches based on inverted indices are efficient only when it is sufficient to search over a relatively small set of inverted indices for each query, e.g., when the scoring rule is extremely sparse, with most words or features in the page having zero contribution to the score for the query q.

Improved indexing and searching methods are desired.

### SUMMARY OF THE INVENTION

In some embodiments, a processor implemented method comprises providing an index which, given a set of inputs, a set of outputs, a set of input categories, and a scoring rule, provides a respective ordered subset of the outputs for each input category. The outputs within each subset are ordered by predicted score of those outputs with respect to a respective input from a respective one of the input categories. An input is received after providing the index. The input corresponds to at least one of the set of input categories. A reduced set of outputs is scored against the received input using the scoring rule. The reduced set of outputs includes a union of the respective subsets of the set of outputs associated with each of the input categories to which the received input corresponds. A list including a subset of the reduced set of outputs having the highest scores is output to a tangible machine readable storage medium, display or network.

In some embodiments, a system comprises a machine readable storage medium having an index that, given a set of inputs, a set of outputs, a set of input categories, and a scoring rule, provides a respective ordered subset of the outputs for each input category. The outputs within each subset are ordered by predicted score of those outputs with respect to a respective input from a respective one of the input categories. At least one processor is capable of receiving an input corresponding to at least one of the set of input categories. The at least one processor is configured for scoring a reduced set of outputs against the received input using the scoring rule. The reduced set of outputs includes a union of the respective subsets of the set of outputs associated with each of the input categories to which the received input corresponds. The at least one processor is configured for outputting a list including a subset of the reduced set of outputs having the highest scores.

In some embodiments, a machine readable storage medium is encoded with computer program code, such that, when the computer program code is executed by a processor, the processor performs a method comprising providing an index which, given a set of inputs, a set of outputs, a set of input categories, and a scoring rule, provides a respective ordered subset of the outputs for each input category. The outputs within each subset are ordered by predicted score of those outputs with respect to a respective input from a respective one of the input categories. An input is received after providing the index. The input corresponds to at least one of the set of input categories. A reduced set of outputs is scored against the received input using the scoring rule. The reduced set of outputs includes a union of the respective subsets of the set of outputs associated with each of the input categories to which the received input corresponds. A list including a subset of the reduced set of outputs having the highest scores is output to a tangible machine readable storage medium, display or network.

### BRIEF DESCRIPTION OF THE DRAWINGS

FIG. 1 is a block diagram of an embodiment of a system described herein.

FIG. 2A is a flow chart of a method for forming a predictive index that defines a reduced set of outputs to be searched in response to a query having an input.

FIG. 2B is a flow chart of a method of searching the predictive index provided in FIG. 2A.

FIG. 3 is a flow chart of an example for indexing and searching for documents or web pages using input features.

FIG. 4 is a flow chart of an example for indexing and searching for advertisements having high predicted click through rate when rendered in conjunction with input web pages.

FIG. 5 is a flow chart of an example for indexing and searching for nearest neighbors to an input point in a Euclidean space.

### DETAILED DESCRIPTION

This description of the exemplary embodiments is intended to be read in connection with the accompanying drawings, which are to be considered part of the entire written description. Terms concerning coupling and the like, such as “connected” and “interconnected,” refer to a relationship wherein computers and/or computer or digital signal processor (DSP) implemented processes are connected to each other or to other devices directly or indirectly, and may be via wired or wireless interfaces, I/O interfaces or a communications network, or other electronic or optical paths, unless expressly described otherwise.

The inventors have provided a system and method to quickly return the highest scoring search results as ranked by potentially complex scoring rules, such as rules typical of learning algorithms. The method and system may be applied to a variety of computer implemented database search applications such as, but not limited to, searching for documents most relevant to a query comprising input words and/or phrases, searching for online advertisements most likely to be clicked through when displayed in conjunction with an input web page, and searching for data points that are the nearest neighbors to an input data point in an N-dimensional Euclidean space. These are just a few examples. The method and system may be applied to provide a predictive index in a variety of applications. Given an input, the predictive index provides a reduced set of possible outputs to be searched, allowing rapid response.

Predictive Indexing describes a method for rapidly retrieving the top elements over a large set as determined by general scoring functions. To mitigate the computational difficulties of search, the data are pre-processed, so that far less computation is performed at runtime. Taking the empirical probability distribution of queries into account, scores are pre-computed for collections of documents (e.g., web pages or advertisements) or data points that have a large predicted score conditioned on the query falling into particular sets of related queries {Qᵢ}. For example, the system may pre-compute and store in an index the subset of the collection comprising a list of web pages that have the highest average score when the query contains the phrase “machine learning”. These subsets should form meaningful groups of pages with respect to the scoring function and query distribution. At runtime, the system then optimizes only over those subsets of the collection listing the top-scoring web pages for sets Qᵢ containing the submitted query.

Some embodiments include optimizing the search index with respect to the query distribution. Predictive indexing is an effective technique, making general machine learning style prediction methods viable for quickly ranking over large numbers of objects.

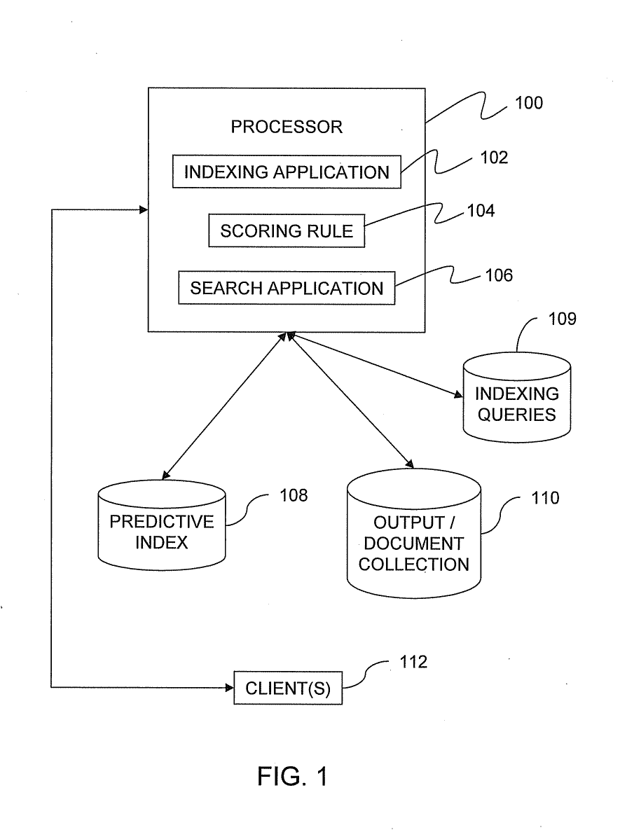

FIG. 1 is a schematic block diagram of an exemplary system. The system includes at least one processor 100, which hosts an indexing application 102 and a search application 106. Both the indexing application 102 and the search application 106 apply a scoring rule 104 for evaluating candidate outputs.

The scoring rule 104 determines how the score for a given output document/point is determined, given a query. For example, in one embodiment, the output/document collection 110 is a set of web pages; each input is a feature (e.g., a string, word or phrase); and the scoring rule 104 may be a count of the number of times the string, word or phrase appears in a given document. In other embodiments, scoring rule 104 takes additional factors into account, such as giving greater weight to inclusion of a query input feature in the title, keywords, or abstract of a document than if the same input appears in the body of the document. Other scoring rules may give higher weight for an occurrence of the exact literal wording of the query, and a lower weight for a variation of the wording, or for a related term that does not include the literal text of the query term. These are only examples, and a variety of other scoring rules may be used.

The indexing application 102 performs predictive indexing by predicting scores for each one of a set of indexing queries 109, which are expected inputs, and identifying a respective candidate output set (subset of the collection 110) associated with each respective input category in the indexing queries set 109. All of the candidate output sets are stored in the predictive index 108. Subsequently, when an actual query is received, a search is conducted over the union of the candidate output sets associated with each input. This is a much smaller search space than the entire output/document collection 110, allowing the predictive index 108 to be searched for handling any given query much more quickly than a search of the entire output document collection 110.

The at least one processor 100 may include a single processor or a plurality of separate processors for hosting the indexing application 102 and search application 106, respectively. If plural processors 100 are included, zero, one, or more than one of the processors 100 may be co-located with the predictive index 108, indexing queries 109, and the output (or document) collection 110. Alternatively, zero, one, or more than one of the processors 100 may be located remotely from the predictive index 108, indexing queries 109, and the output (or document) collection 110. The system is also accessible by one or more clients 112, which may include any combination of co-located and/or remote hosts having an interface for submitting a query to the searching application. For example, the interface may be a browser based graphical user interface capable of running in Internet Explorer by Microsoft Corporation of Redmond, Wash. Any of the processors(s) 100 and client(s) 112 may be connected to any other processor or client by way of a network (not shown), such as a local area network, wide area network, or the internet.

The general methodology applies to other optimization problems as well, including approximate nearest neighbor search.

Feature Representation

The system has inputs (e.g., query features, web pages, or data points) and respective outputs (e.g., documents relevant to the query features, advertisements most likely to be clicked if rendered with the web pages, or nearest neighboring data points).

One concrete way to map web search into the general predictive index framework is to represent both queries and pages as sparse binary feature vectors in a high-dimensional Euclidean space. Specifically, the system associates each word with a coordinate: A query (page) has a value of 1 for that coordinate if it contains the word, and a value of 0 otherwise. This is a word-based feature representation, because each query and page can be summarized by a list of its features (i.e., words) that it contains. The general predictive framework supports many other possible representations, including those that incorporate the difference between words in the title and words in the body of the web page, the number of times a word occurs, or the IP address of the user entering the query.

An Algorithm for Rapid Approximate Ranking

The system is provided with a categorization of possible indexing queries 109 into related, potentially overlapping, sets. For example, these sets might be defined as, “queries containing the word ‘France’,” or “queries with the phrase ‘car rental’.” For each query set 109, the associated predictive index 108 is an ordered list of outputs sorted by their expected score for random queries drawn from that set. In particular, one expects web pages at the top of the ‘France’ list to be good, on average, for queries containing the word ‘France.’ The pages in the ‘France’ list need not themselves contain the word ‘France’. For example, inclusion of ‘Paris’ may qualify a document for inclusion in the ‘France’ list, because pages with this word may score high, on average, for queries containing ‘France’.

After completion of the predictive index 108, a live search requesting information from the collection 110 can be performed by searching the predictive index 108, instead of searching the entire collection 110. To retrieve results for a particular query (e.g., “France car rental”), the system optimizes only over web pages in the relevant, pre-computed lists within predictive index 108 (e.g., the union of the ‘France’ list and the ‘car rental’ list). Note that the predictive index 108 is built on top of an already existing categorization of indexing queries 109.

In some embodiments, the indexing query set 109 is selected empirically based on a sample of real queries. However, in the applications considered, predictive indexing works well even when applied to naively defined query sets (e.g., forming indexing query set 109 to include each individual word in a complete dictionary).

The system represents inputs (e.g., queries) and outputs (e.g., web pages) as points in, respectively, Q⊂Rⁿ and W⊂R^{m}. This setting is general, but as an example, consider n, m≅10⁶, with any given page or query having about 10² non-zero entries. Thus, pages and points are typically sparse vectors in very high dimensional spaces. A coordinate may indicate, for example, whether a particular word is present in the page/query, or more generally, the number of times that word appears. Given a scoring function ƒ: Q×W→R, and a query q, the system attempts to rapidly find the top-k pages p₁, . . . , pₖ. Typically, the system finds an approximate solution, a set of pages \hat{p}₁, . . . , \hat{p}ₖ that are among the top l for l≅k. These pages \hat{p}₁, . . . , \hat{p}ₖ form a subset associated with q in the predictive index 108 The system assumes queries are generated from a probability distribution D that may be sampled.

For each set 109 of indexing queries Qᵢ the system pre-computes a sorted list Lᵢ of pages pᵢ_{₁}, pᵢ_{₂}, . . . , pᵢ_{_{N}} ordered in descending order of ƒ₁(p). At runtime, given a query q, the system identifies the indexing query sets Qᵢ within index 108 containing q, and computes the scoring function ƒ only on the reduced set of pages, and in some embodiments, only at the beginning of their associated lists Lᵢ. In some embodiments, the system searches down these lists for as long as the computational budget allows. Depending on the computational budget allowed, the processing of a search query may include searching over a respective subset containing the top 100 items associated with each respective feature in the search query, or the top 1000 items associated with each feature. These are only examples, and any search budget may be used, influencing the number of items in the predictive index 108 searched in response to a single query. Also, although some embodiments allocate a fixed time budget for each query (possibly resulting in more items per feature being searched if the search query only includes one or two features), other embodiments allow a larger total time budget for search queries having multiple features.

Predictive Indexing for General Scoring Functions

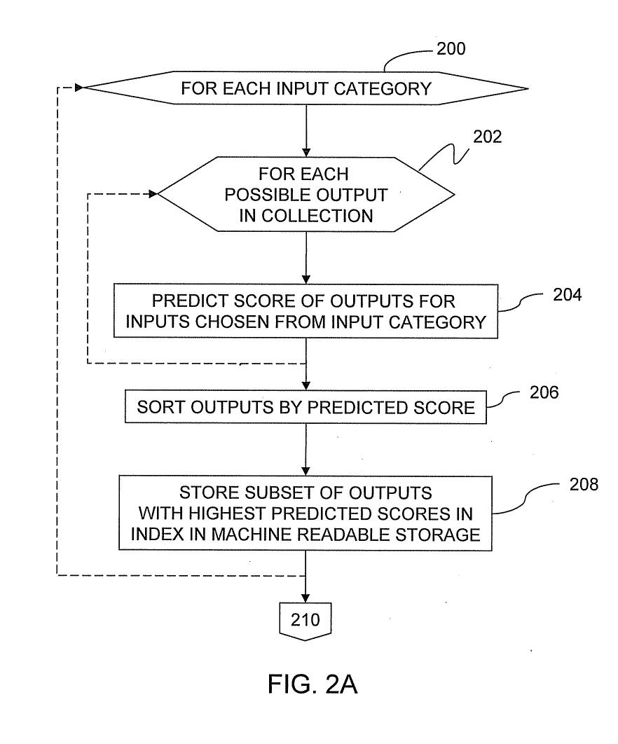

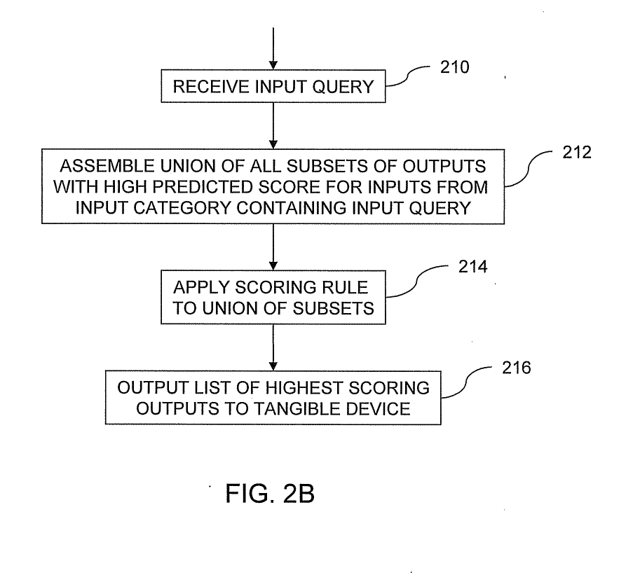

FIG. 2A is a flow chart of a method according to one embodiment.

At step 200, an outer loop including steps 202-208 is repeated for each input category in the indexing queries set 109, to be included in the predictive index 108. This loop may be performed by the indexing application 102. The set 109 of indexing query input categories is a pre-determined set of single feature input queries. A given category is associated with a plurality of inputs, such that a subset of the outputs to be associated with the same category will be subsequently searched if any of the inputs appears as a parameter of a query. For example, the terms, “terrier” and “Chihuahua”, may be associated with the input category “dogs”, so that a subset of documents associated with dogs is searched any time a subsequent keyword search query includes either of the keywords, “terrier” and “Chihuahua”. In another example, where the individual inputs are data points in a Euclidean space, an input category may include a cluster of points in the same Euclidean space selected by a clustering algorithm.

The set 109 of indexing query inputs may be provided by a variety of mechanisms, such as selecting all terms from a dictionary, or collecting a representative sample of empirical input queries from a database query history and identifying the individual strings, words or phrases appearing in the sampled queries. Yet another technique for providing the indexing query set 109 is to select a representative sample of the document collection 110, and extract a set of the features from that sample for use as the indexing query set 109.

At step 202, an inner loop including step 204 is repeated for each object in the output or document collection 110.

At step 204, the score of the outputs are predicted for each input chosen from the input category.

At step 206, a subset of outputs having the highest predicted scores (which are to be associated with the input category) is determined, and the subset of outputs is sorted by predicted score. In some embodiments, any output with a non-zero score is included in the subset associated with the input category. In other embodiments, a predetermined number of outputs having the highest scores are included in the subset associated with the input.

At step 208, the subset of outputs associated with the particular input category and having the highest predicted scores is stored in predictive index 108, which resides in a tangible, machine readable storage medium.

One of ordinary skill will understand that steps 200-208 can be performed offline, in advance of receipt of any actual search queries. In the event that new input categories are added to the input set (of indexing queries) 109, the loop of steps 200-208 can be repeated for the new input categories to supplement the predictive index 108 without repeating all of the previous predictive index data, because the predictive index 108 stores data based on application of the scoring rule to each input category separately. If new output data are to be added to the output space (document collection 110), then the predictive indexing steps 200-208 can be repeated (e.g., periodically, on a schedule, in batch mode), so that the subset of outputs associated with each individual input category reflects the solution set for the expanded output space.

FIG. 2B is a flow chart of a method of searching the index provided by the method of FIG. 2A. The steps 210-216 are typically preformed online, in response to a live query, and may be performed in the same processor that performs the indexing method (steps 200-208) or in a different processor. Steps 210-216 are performed by the search application 106, which may be hosted in the same processor 100 as, or a separate processor from, indexing application 102. There may optionally be a substantial delay between the indexing steps (FIG. 2A) and the searching steps (FIG. 2B).

At step 210, the search application receives an input query.

At step 212, the search application determines what inputs are contained in the query, and retrieves from predictive index 108 all of the subsets containing the outputs having the highest predicted scores among the outputs associated with the inputs in each input category of the query. The search application forms a reduced data set over which it will perform the search, by forming the union of all of the subsets of outputs having the highest predicted scores among those associated with the individual features in the input query. This reduced data set may have a size that is two, three, four or more orders of magnitude smaller than the entire document collection 110. For example, as described above, for a given input feature, with a document collection 110 having 1,000,000 documents, the number of documents in the subset associated with that one feature may be on the order of 100.

At step 214, the scoring rule 104 is applied to compute scores for each of the data points (potential outputs) in the reduced data set. Although the scoring rule 104 used in this step can be the same scoring rule applied in step 204, the input query can include a plurality of features (or data points) in step 214. For example, if the scoring rule takes proximity between keywords into account, isolated instances of one of the query terms may not contribute to the score of the multi-feature query. Thus, one of ordinary skill will understand that the predictive index 108 provides a smaller search space over which a live online search is performed using all the input features and applying all of the scoring rule parameters.

At step 216, search application 106 outputs a list of the highest scoring outputs to a tangible output or storage device. For example, the list may be arranged in descending order by score.

In general, at the time of forming the predictive index 108 (steps 200-208) it is difficult to compute exactly the conditional expected scores of pages ƒᵢ(p). One can, however, approximate these scores by sampling from the query distribution D (query set 109). Two sets of pseudo code are provided below for the indexing and searching techniques, respectively. Algorithm 1 outlines the construction of the sampling-based predictive indexing data structure 108 in FIG. 2A. Algorithm 2 shows how the method operates at run time in FIG. 2B.

In the special case where the system covers Q with a single set, the system ends up with a global ordering of outputs (e.g., web pages), independent of the query, which is optimized for the underlying query distribution. While this global ordering may not be effective in isolation, it could perhaps be used to order pages in traditional inverted indices.

An example below helps develop intuition for why predictive indexing may improve upon other techniques. Assume that the system has: two query features t₁ and t₂; three possible queries q₁={t₁}, q₂={t₂}, and q₃={t₁,t₂} and three web pages p₁, p₂ and p₃. Further assume that the system has a simple linear scoring function defined by

ƒ(q,p₁)=Iₜ_{₁}_{eq}−Iₜ_{₂}_{eq} ƒ(q,p₂)=Iₜ_{₂}_{eq}−Iₜ_{₁}_{eq} ƒ(q,p₃)=0.5·Iₜ_{₂}_{eq}+0.5·Iₜ_{₁}_{eq}

Algorithm 1 Construct-Predictive-Index(Cover Q, Dataset S)

```
Lⱼ[s]= 0 for all objects s and query sets Qⱼ.
for t random queries q ~ D do
  for all objects s in the data set do
    for all query sets Qⱼ containing q do
      Lⱼ[s]← Lⱼ[s]+ f(q,s)
    end for
  end for
end for
for all lists Lⱼ do
  sort Lⱼ
end for
return {L}
```

Algorithm 2 Find-Top(query q, count k)

```
i = 0
top-k list V = Ø
while time remains do
  for each query set Qⱼ containing q do
    s ← Lⱼ[i]
    if f(q, s) > k^{th} best seen so far then
      insert s into ordered top-k list V
    end if
  end for
  i ← i + 1
end while
return V
```

where I is the indicator function. That is, pᵢ is the best match for query qᵢ, but p₃ does not score highly for either query feature alone. Thus, an ordered, projective data structure would have

t₁←{p₁, p₃, p₂} t₂←{p₂, p₃, p₁}.

Suppose, however, that the system typically only sees query q₃. In this case, if it is known that t₁ is in the query, the system infers that t₂ is likely to be in the query (and vice versa), and construct the predictive index

t₁←{p₃, p₁, p₂} t₂←{p₃, p₁, p₂}.

On the high probability event, namely query q₃, the predictive index outperforms the projective, query independent, index.

A first example below involves a query for documents (e.g., web pages) most relevant to a set of one or more query features (which may be words and/or phrases).

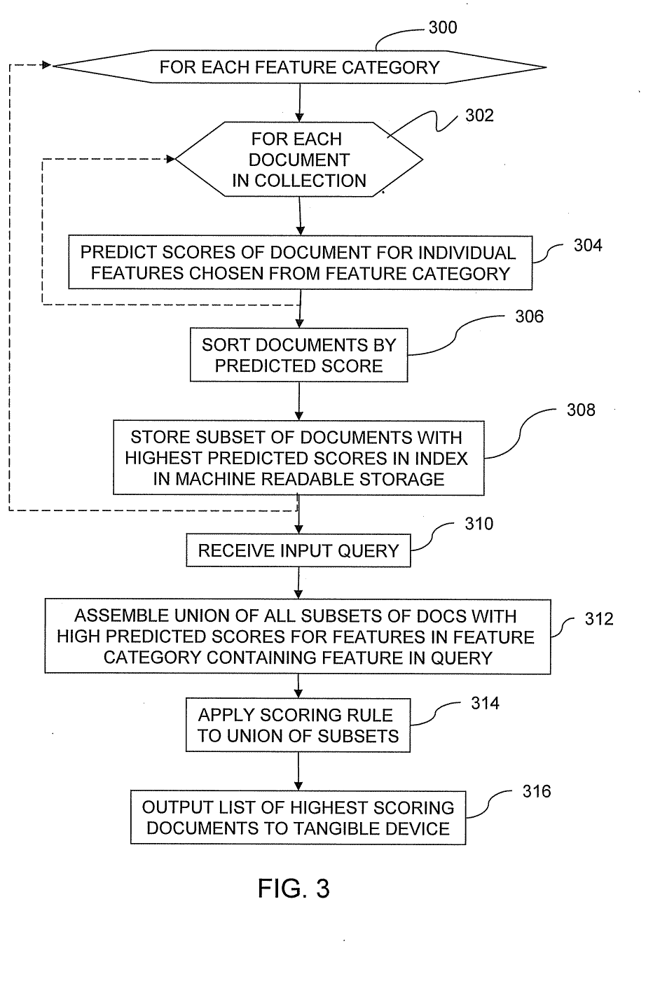

FIG. 3 is a flow chart of a method for providing a ranked list of top documents corresponding to a query comprising at least one feature, according to one example of the technique shown in FIGS. 2A and 2B. In FIG. 3, the two processes (indexing and querying) are both shown in a single figure, but one of ordinary skill will understand that the execution of these two processes may be performed using either the same processor or separate processors for the indexing and querying processes, respectively, and there may optionally be a substantial delay between the indexing steps (302-308) and the searching steps (310-316).

In the example of FIG. 3, the input categories are defined by features (e.g., strings, words or phrases), and the outputs are relevant documents. The document collection 110 may be any document collection, including but not limited to, the documents on the World Wide Web, or any database of locally or remotely stored documents.

At step 300, an outer loop including steps 302-308 is repeated for each input feature (e.g., string, word or phrase) in the categories in the indexing queries set 109, to be included in the predictive index 108. This loop may be performed by the indexing application 102. The set 109 of indexing query inputs is a pre-determined set of single feature input queries.

At step 302, an inner loop including step 304 is repeated for each document in the document collection 110.

At step 304, the predicted scores of the document for the individual features chosen from the feature category are computed.

At step 306, the documents are sorted by predicted scores for the individual feature to form a subset of documents to be associated with that feature category. In other embodiments, a predetermined number of documents having the highest predicted scores are included in the subset associated with the feature category. In some embodiments, any document with a non-zero score is included in the subset associated with the feature category.

At step 308, the subset of documents with the highest predicted scores associated with the particular feature category is stored in predictive index 108, which resides in a tangible, machine readable storage medium.

One of ordinary skill will understand that steps 300-308 can be performed offline, in advance of receipt of any actual search queries. In the event that new feature categories are added to the input set (of indexing queries) 109, the loop of steps 300-308 can be repeated for the new feature categories to supplement the predictive index 108 without repeating all of the previous predictive index data, because the predictive index 108 stores data determined by predicting a respective score for each input feature category separately. If new documents are to be added to the document collection 110, then the predictive indexing steps 300-308 can be repeated (e.g., periodically, on a schedule, in batch mode), so that the subset containing the highest scoring documents associated with each individual feature category reflects the solution set for the expanded document collection.

The remaining steps 310-316 are typically preformed online, in response to a live query. Steps 310-316 are performed by the search application 106, which may be hosted in the same processor 100 as, or a separate processor from, indexing application 102.

At step 310, the search application 106 receives an input query.

At step 312, the search application 106 determines what features are contained in the query, and retrieves from predictive index 108 all of the subsets of the documents having the highest predicted scores among documents associated with the feature categories associated with each feature in the query. The search application 106 forms a reduced document set over which it will perform the search, by forming the union of all of the subsets of documents with highest predicted scores among documents associated with the individual features in the input query. This reduced document set may have a size that is two, three, four or more orders of magnitude smaller than the entire document collection 110. For example, as described above, for a given input feature, with a document collection 110 having 1,000,000 documents, the number of documents in the subset associated with that one feature may be on the order of 100.

At step 314, the scoring rule 104 is applied to compute scores of each of the documents (potential outputs) in the reduced document set. Although the scoring rule 104 used in this step can be the same scoring rule applied in step 304, the input query can include a plurality of features spread over a plurality of feature categories in step 314. For example, if the scoring rule takes proximity between keywords into account, isolated instances of one of the query terms may not contribute to the score of the multi-feature query.

At step 316, search application 106 outputs a list of the highest scoring documents to a tangible output or storage device. For example, the list may be arranged in descending order by score.

Another example in which the predictive index may be used is Internet advertising. Note that the role played by web pages has switched, from output to input. The user of the predictive index inputs a web page, and receives as output a list of highest scoring advertisements, which are most likely to be clicked if rendered along with the input web page.

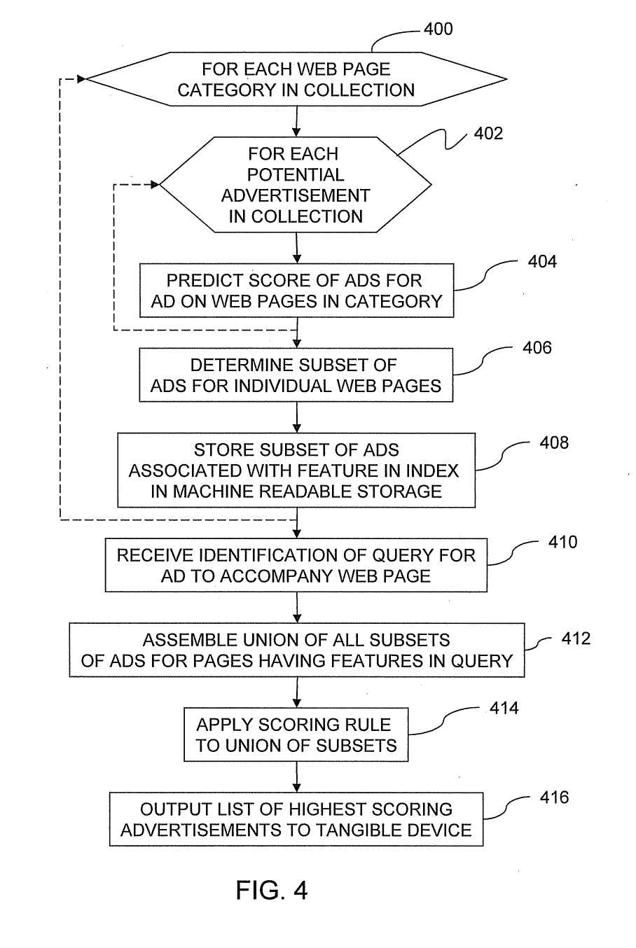

FIG. 4 is a flow chart of a method for generating a ranked list of the top advertisements to be rendered in conjunction with a given web page, according to one example of the technique shown in FIGS. 2A and 2B. In this example, for any given web page category in the input collection, the predictive index can provide a relatively small set of candidate advertisements to be scored for determining the advertisement having the highest score (indicating the greatest likelihood of being clicked through when rendered along with a given web page within that category).

In FIG. 4, the two processes (indexing and querying) are both shown in a single figure, but one of ordinary skill will understand that the execution of these two processes may be performed using either the same processor or separate processors for the indexing and querying processes, respectively. Optionally, there may be a substantial delay between the indexing steps (400-408) and the searching steps (410-416).

In the example of FIG. 4, the input categories are web pages, and the outputs are relevant advertisements that can be rendered along with the web page. More specifically, the outputs of a given search are the highest scoring advertisements among the advertisements that can be rendered with a given web page, where the highest scores indicate the greatest probability that a user will click through that ad if it is rendered along with the given page. The web page collection 110 may be any set of web pages, including but not limited to, any subset of the documents on the World Wide Web.

At step 400, an outer loop including steps 402-408 is repeated for each web page category in the indexing queries set 109, to be included in the predictive index 108. This loop may be performed by the indexing application 102. The set 109 of indexing query inputs is a pre-determined set of web page category queries. The pre-determined web page queries may represent individual pages or categories of web pages (e.g., web pages about food, science, politics, or religion).

At step 402, an inner loop including step 404 is repeated for each advertisement in the advertisement collection 110.

At step 404, the scores of the advertisements for the individual web page categories are predicted.

At step 406, the advertisements are sorted by predicted scores for the individual web page category to form a subset of advertisements to be associated with that web page category. In other embodiments, a predetermined number of advertisements having the highest predicted scores are included in the subset associated with the web page or web page category. In some embodiments, any advertisement with a non-zero predicted score is included in the subset associated with the web page category.

At step 408, the subset of advertisements with the highest predicted scores associated with the particular web page category is stored in predictive index 108, which resides in a tangible, machine readable storage medium.

One of ordinary skill will understand that steps 400-408 can be performed offline, in advance of receipt of any actual search queries. In the event that new web page categories are added to the input set (of web page category queries) 109, the loop of steps 400-408 can be repeated for the updated web page category data to supplement the predictive index 108 without repeating all of the previous predictive index data, because the predictive index 108 stores data determined by predicting a respective score for each web page category separately. If new advertisements are to be added to the collection 110 of potential advertisements, then the predictive indexing steps 400-408 can be repeated (e.g., periodically, on a schedule, in batch mode), so that the subset containing the highest scoring advertisements associated with each individual web page category reflects the solution set for the expanded advertisement collection.

The remaining steps 410-416 are typically preformed online, in response to a live query. Steps 410-416 are performed by the search application 106, which may be hosted in the same processor 100 as, or a separate processor from, indexing application 102.

At step 410, the search application 106 receives an input query identifying a web page.

At step 412, the search application 106 determines what web page(s) are contained in the query, and retrieves from predictive index 108 all of the subsets of the documents having the highest predicted scores among documents associated with each web page in the same web page category as the web page in the query. The search application 106 forms a reduced advertisement set over which it will perform the search, by forming the union of all of the subsets of advertisements with highest predicted scores among advertisements associated with the individual web page(s) in the input query. This reduced advertisement set may have a size that is two, three, four or more orders of magnitude smaller than the entire advertisement collection 110. For example, as described above, for a given input web page, with an advertisement collection 110 having 1,000,000 advertisements, the number of advertisements in the subset associated with that one web page may be on the order of 100.

At step 414, the scoring rule 104 is applied to compute scores of each of the advertisements (potential outputs) in the reduced advertisement set. Although the scoring rule 104 used in this step can be the same scoring rule applied in step 404, the input web page query can include a plurality of web pages and/or web page categories (with one or more optional parameters) in step 414. For example, a multi-category query might ask which advertisements score most highly for both of a pair of web pages including one page from the food category and one page from the science category.

At step 416, search application 106 outputs a list of the highest scoring advertisements to a tangible output or storage device. For example, the list may be arranged in descending order by score.

To construct an index for the embodiment of FIG. 4, testing and training data, can be obtained from an online advertising company, for example. The data are comprised of logs of events, where each event represents a visit by a user to a particular web page p, from a set of web pages Q⊂Rⁿ. From a large set of advertisements W⊂R^{m}, the commercial system chooses a smaller, ordered set of ads to display on the page (generally around 4). The set of ads seen and clicked by users is logged.

In one example, a system was tested in which the total number of ads in the data set was |W|≅6.5×10⁵. Each ad contained, on average, 30 ad features, and a total of m≅10⁶ ad features were observed. The training data included 5 million events (web page x ad displays). The total number of distinct web pages was 5×10⁵. Each page included approximately 50 page features, and a total of n≅9×10⁵ total page features were observed.

The system used a sparse feature representation and trained a linear scoring rule ƒ of the form η(p,a)=Σ_{i,j}w_{i,j}pᵢaⱼ, to approximately rank the ads by their probability of click. Here, w_{i,j} are the learned weights (parameters) of the linear model. The search algorithms were given the scoring rule ƒ, the training pages, and the ads W for the necessary pre-computations. They were then evaluated by their serving of k=10 ads, under a time constraint, for each page in the test set. There was a clear separation of test and training data. Computation time was measured in terms of the number of full evaluations by the algorithm (i.e., the number of ads scored against a given page). Thus, the true test of an algorithm was to quickly select the most promising T ads to fully score against the page, where T∈{100, 200, 300, 400, 500} was externally imposed and varied over the experiments. These numbers were chosen to be in line with real-world computational constraints.

Approximate Nearest Neighbor Search

Another application of predictive indexing is approximate nearest neighbor search. Given a set of points W in d-dimensional Euclidean space, and a query point x in that same space, the nearest neighbor problem seeks to quickly return the top-k neighbors of x. This problem is of considerable interest for a variety of applications, including data compression, information retrieval, and pattern recognition. In the predictive indexing framework, the nearest neighbor problem corresponds to optimizing against a scoring function ƒ(x, y) defined by Euclidean distance. The system assumes that query points are generated from a distribution D that can be sampled.

A covering of the space may be according to locality-sensitive hashing (LSH) as described in Gionis, A., Indyk, P., & Motwani, R., “Similarity search in high dimensions via hashing,” The VLDB Journal (pp. 518-529) (1999), and Datar, M., Immorlica, N., Indyk, P., & Mirrolcni, V. S., “Locality-Sensitive Hashing Scheme Based on Pstable Distributions”, SCG '04: Proceedings of the twentieth annual symposium on Computational geometry (pp. 253-262), New York, N.Y., USA: ACM. (2004). LSH is a suggested scheme for the approximate nearest neighbor problem. Namely, for fixed parameters m, k and l≦i≦m and l≦j≦k, generate a random, unit-norm d-vector Yᵢⱼ=(Yᵢⱼ_{₁}, . . . , Yᵢⱼ_{_{d}}) from the Gaussian (normal) distribution. For J⊂{1, . . . ,k} define the cover set Q_{i,j}={x∈R^{d}:x·Yᵢ_{ⱼ}≧0 if and only if j∈J}. In some embodiments, for fixed i, the set {Q_{i,j}}_{J⊂{1, . . . ,k}} partitions the space by random planes.

Given a query point x, standard LSH approaches to the nearest neighbor problem work by scoring points in the set Qₓ=W∩(∪_{Qi.J ∈x}Q_{i,J}). That is, LSH considers only those points in W that are covered by at least one of the same m sets as x. Predictive indexing, in contrast, maps each cover set Q_{i,J} to an ordered list of points sorted by their probability of being a top-10 nearest point to points in Q_{i,J} (or any other selected number of nearest points). That is, the lists are sorted by h_{Qi,J}(p)=Pr_{q˜D|Qi,J} (p is one of the nearest 10 points to q). For the query x, those points in W with large probability h_{Qi,J} for at least one of the sets Q_{i,J} that cover x are considered.

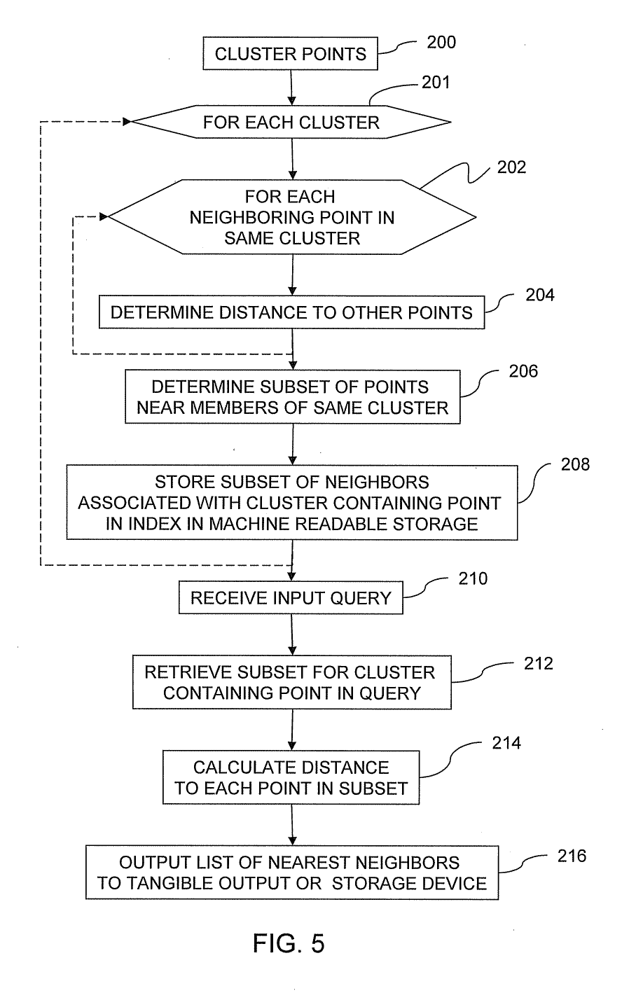

FIG. 5 is a flow chart of a method for selecting a ranked list of the nearest neighbors to a given input point in a Euclidean space, according to one example of the technique shown in FIGS. 2A and 2B. In this example, for any given point within a cluster in the Euclidean space, the predictive index can provide a relatively small set of candidate points to be scored for determining the points having the highest score (indicating closest proximity in the Euclidean space). It is possible for two or more distinct points to be equidistant from the input point, separated from the input point by vectors of the same magnitude but different directions.

In FIG. 5, the two processes (indexing and querying) are both shown in a single figure, but one of ordinary skill will understand that the execution of these two processes may be performed using either the same processor or separate processors for the indexing and querying processes, respectively. Optionally, there may be a substantial delay between the indexing steps (500-508) and the searching steps (510-516).

In the example of FIG. 5, the input categories are data points, and the outputs are nearest neighbor points in the multi-dimensional Euclidean space.

At step 500, the points in the Euclidean space may be grouped into partitions or clusters. For example, in some embodiments, the space may be evenly partitioned into a plurality of like-sized regions (e.g., a set of cuboids within a three-dimensional X, Y, Z space). In other embodiments, a clustering algorithm may be used to assign each point to a respective cluster. In other embodiments, the partitions may be sized differently from one another. For example, higher density partitions (those having a greater concentration of data points) may be divided into further smaller partitions.

For the purpose of this predictive index, the particular algorithm used to group the points into partitions or clusters is not critical. Using some algorithms, an input point within a first partition or cluster may have a nearest neighbor assigned to a second partition or cluster. For each partition the indexing process identifies points that are near to the points in that partition or cluster, regardless of whether actually located in the same partition/cluster or a neighboring partition/cluster. Thus, for a point on or near a boundary of the partition or cluster, there will be many points in a neighboring partition/cluster that are closer than some of the points within the same partition or cluster. The predictive index includes, for each partition or cluster, a subset of points in the Euclidean space that may be a nearest neighbor to any of the points in that partition or cluster. For this reason, the precision of the partitioning or clustering algorithm is not critical to the ability of the method of FIG. 5 to provide a predictive index with a reduced set of data points to be searched in a nearest neighbor search given an input data point.

For example, in a three dimensional X, Y, Z space, the subset of points in the predictive index associated with a given 10×10×10 cubic partition may be the set of all points within a larger 12×12×12 cube surrounding that 10×10×10 cubic partition. For a point on the boundary of the 10×10×10 cube, many of the nearest neighbor points will be located between the boundary of the 12×12×12 cube and the boundary of the 10×10×10 cube. These points lie outside of the 10×10×10 partition.

At step 501, an outer loop including steps 502-508 is repeated for each partition or cluster in the Euclidean space to be used for the indexing queries set 109, to be included in the predictive index 108. This loop may be performed by the indexing application 102. The set 109 of indexing query inputs is a pre-determined set of partitions or clusters.

At step 502, an inner loop including step 504 is repeated for each point in the Euclidean space 110.

At step 504, the Euclidean distance of each point from the cluster or partition is computed.

At step 506, the points are sorted by distance from points within the cluster or partition to form a subset of neighboring points to be associated (in the predictive index) with that cluster or partition. In other embodiments, a predetermined number of nearby points are included in the subset associated with the cluster or partition. In some embodiments, any neighboring point with a distance below a predetermined value is included in the subset of points associated with the cluster or partition.

At step 508, the subset of neighboring points associated with the particular cluster or partition is stored in predictive index 108, which resides in a tangible, machine readable storage medium.

The remaining steps 510-516 are typically preformed online, in response to a live query. Steps 510-516 are performed by the search application 106, which may be hosted in the same processor 100 as, or a separate processor from, indexing application 102.

At step 510, the search application 106 receives an input query identifying one or more points in the Euclidean space.

At step 512, the search application 106 determines what point(s) are contained in the query, and retrieves from predictive index 108 all of the subsets of the points associated with each cluster or partition having points included in the query. The search application 106 forms a reduced set of points over which it will perform the search, by forming the union of all of the points in the index corresponding to neighbors of the partitions or clusters containing the points in the input query. This reduced set of points may have a size that is two, three, four or more orders of magnitude smaller than the entire Euclidean space 110.

At step 514, the scoring rule 104 is applied to compute distances of each of the points (potential outputs) in the reduced set of points of step 512.

At step 516, search application 106 outputs a list of the nearest points to a tangible output or storage device. For example, the list may be arranged in descending order by score.

Although examples of predictive indexes are described above, these are only illustrations and are not an exclusive list. Predictive indexing is capable of supporting scalable, rapid ranking based on general purpose machine-learned scoring rules for a variety of applications. Predictive indices should generally improve on data structures that are agnostic to the query distribution.

The present invention may be embodied in the form of computer-implemented processes and apparatus for practicing those processes. The present invention may also be embodied in the form of computer program code embodied in tangible machine readable storage media, such as random access memory (RAM), floppy diskettes, read only memories (ROMs), CD-ROMs, DVDs, hard disk drives, flash memories, or any other machine-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, such that, when the computer program code is loaded into and executed by a computer, the computer becomes an apparatus for practicing the invention. When implemented on a general-purpose processor, the computer program code segments configure the processor to create specific logic circuits. The invention may alternatively be embodied in a digital signal processor formed of application specific integrated circuits for performing a method according to the principles of the invention.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A processor implemented method comprising:
(a) providing an index which, given a set of inputs, a set of outputs, a set of input categories, and a scoring rule, provides a respective ordered subset of the outputs for each input category, the outputs within each subset ordered by predicted score of those outputs with respect to a respective input from a respective one of the input categories;
(b) receiving an input after step (a), the input corresponding to at least one of the set of input categories;
(c) scoring a reduced set of outputs against the received input using the scoring rule, the reduced set of outputs including a union of the respective subsets of the set of outputs associated with each of the input categories to which the received input corresponds; and
(d) outputting to a tangible machine readable storage medium, display or network a list including a subset of the reduced set of outputs having the highest scores.

2. The method of claim 1, wherein the outputs are web pages, and the plurality of inputs includes at least one of the group consisting of words and phrases.

3. The method of claim 2, wherein the query is a request for a list of web pages most relevant to words or phrases in the query.

4. The method of claim 1, wherein the outputs are advertisements, and the inputs are web pages.

5. The method of claim 4, wherein the query is a request for a list of advertisements most likely to be clicked if rendered in conjunction with a web page identified in the query.

6. The system of claim 1, wherein the inputs are points in a Euclidean space, and the respective outputs are nearest neighbors to the respective input points.

7. A system comprising:
a machine readable storage medium having an index that, given a set of inputs, a set of outputs, a set of input categories, and a scoring rule, provides a respective ordered subset of the outputs for each input category, the outputs within each subset ordered by predicted score of those outputs with respect to a respective input from a respective one of the input categories;
at least one processor capable of receiving an input corresponding to at least one of the set of input categories;;
the at least one processor configured for scoring a reduced set of outputs against the received input using the scoring rule, the reduced set of outputs including a union of the respective subsets of the set of outputs associated with each of the input categories to which the received input corresponds; and
the at least one processor configured for outputting a list including a subset of the reduced set of outputs having the highest scores.

8. The system of claim 7, wherein the inputs are points in a Euclidean space, and the respective outputs are nearest neighbors to the respective input points.

9. The system of claim 7, wherein, the plurality of inputs includes at least one of words or phrases, and the outputs are web pages relevant to the words or phrases.

10. The system of claim 7, wherein the, the inputs are web pages, and the outputs are advertisements likely to be clicked when rendered in conjunction with the web pages.

11. The system of claim 7, wherein the inputs and outputs are represented in the index as sparse binary feature vectors in a Euclidean space.

12. The system of claim 11, wherein the index has a first value corresponding to a combination of one of the inputs and one of the outputs if that output satisfies a predetermined criterion given the input.

13. The system of claim 11, wherein the index has a first value corresponding to a combination of one of the inputs and one of the outputs if that output satisfies a predetermined criterion given the input.

14. The system of claim 11, wherein
the plurality of inputs includes at least one of words or phrases,
the outputs are web pages relevant to the words or phrases,
the index has a first value corresponding to a combination of one of the words or phrases and one of the web pages if that web page contains the one word or phrase; and
the index has a second value corresponding to the combination of the one word or phrase and the one web page if that web page does not contain the one word or phrase.

15. The system of claim 11, wherein the first value
the plurality of inputs includes at least one of words or phrases,
the outputs are web pages relevant to the words or phrases,
the index has a respective value corresponding to each combination of one of the words or phrases and one of the web pages, the value being the number of times that one word or phrase appears in that web page.

16. A machine readable storage medium encoded with computer program code, such that, when the computer program code is executed by a processor, the processor performs a method comprising:
(a) providing an index that, given a set of inputs, a set of outputs, a set of input categories, and a scoring rule, provides a respective ordered subset of the outputs for each input category, the outputs within each subset ordered by predicted score of those outputs with respect to a respective input from a respective one of the input categories;
(b) receiving an input after step (a), the input corresponding to at least one of the set of input categories;
(c) scoring a reduced set of outputs against the received input using the scoring rule, the reduced set of outputs including a union of the respective subsets of the set of outputs associated with each of the input categories to which the received input corresponds; and
(d) outputting to a tangible machine readable storage medium, display or network a list including a subset of the reduced set of outputs having the highest scores.

17. The machine readable storage medium of claim 16, wherein the outputs are web pages, and the plurality of inputs includes at least one of the group consisting of words and phrases.

18. The machine readable storage medium of claim 17, wherein the query is a request for a list of web pages most relevant to words or phrases in the query.

19. The machine readable storage medium of claim 16, wherein the outputs are advertisements, and the inputs are web pages.

20. The machine readable storage medium of claim 19, wherein the query is a request for a list of advertisements most likely to be clicked if rendered in conjunction with a web page identified in the query.

21. The machine readable storage medium of claim 16, wherein the inputs are points in a Euclidean space, and the respective outputs are nearest neighbors to the respective input points.
